(19) United States
(12) Patent Application Publication
(10) Pub. No.: US 2023/0266219 A1
(43) Pub. Date: Aug. 24, 2023

(54) Capillary Viscometer

(71) Applicant: Carlo Dessy, Berlin (DE)

(72) Inventor: Carlo Dessy, Berlin (DE)

(73) Assignee: TESTA Analytical Solutions e.K., Berlin (DE)

(21) Appl. No.: 17/678,825

(22) Filed: Feb. 23, 2022

(51) Int. Cl. G01N 11/04

(52) U.S. Cl. CPC G01N 11/04; G01N 2011/0093

(57) ABSTRACT

A capillary viscometer is disclosed for measuring the relative viscosity of a solute in a solvent. The capillary viscometer consists of a single fluid flow circuit having a measuring capillary and a thermal flow sensor connected in series for in-situ velocity measurement. Relative viscosity is determined by measuring the flow velocity ratio of pure solvent compared to that of a sample. Two different differential viscometers are also disclosed. The first differential viscometer has two fluid flow circuits with one of the circuits also having a large volume vessel to allow for sample dilution. Another configuration of the differential viscometer is disclosed where four fluid flow circuits are configured in a Wheatstone bridge configuration.

### CROSS REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR A JOINT INVENTOR

Not Applicable

### FIELD OF THE INVENTION

This invention relates generally to the field of capillary viscometers, and in particular to a capillary viscometer capable of direct, in-situ flow measurement by thermal flow sensors.

### BACKGROUND OF THE INVENTION

The present invention relates to the field of viscometers, and more specifically to a capillary viscometer. A capillary viscometer is a measuring device for recording the viscosity of a diluted sample. In its simplest form, it consists of a glass capillary with two markings. The sample to be examined is made to flow through the capillary by means of gravity. The viscosity is determined by measuring the transit time of the meniscus from one mark to the next. The measurement is carried out once with pure solvent, then with the sample. The ratio of the transit times then corresponds to the relative viscosity. The time measurement is carried out manually with the aid of a stopwatch or electronically with suitable oil-sensitive sensors. Optical measurement of the flow velocity is difficult, if not impossible, with media that are not translucent. The accuracy of the measurement also depends on surface effects on the capillary wall. The measurement method also requires the use of glass capillaries, which are subject to little mechanical stress.

A differential capillary viscometer is a special form of capillary viscometer and is suitable for continuous measurement of viscosity. As a first example, U.S. Pat. No. 4,463,598 issued to Haney in 1984 entitled “Capillary Bridge Viscometer” discloses a viscometer that includes a bridge with two capillaries in series to measure the relative viscosity of a solute in a solvent. The Haney device operates on the principle of creating a differential pressure across the capillary bridge that is a function of the viscosity of the second liquid relative to a known first liquid viscosity reference. The Haney device has been sold extensively thru a product line known as Viscotek and is now part of Malvern Panalytical. However, the product line has not become a market leader due to other products having similar accuracy but at a lower cost.

The use of differential pressure measurement, however, has significant drawbacks. First, the pressure transducers used must be extremely sensitive, thus resulting in some fragility. Second, the system must always be completely free of air bubbles to provide reliable results. Also, the overall performance of such a device is highly dependent on the performance of the attached pump that delivers the solvent and sample segment through the system. Yet another disadvantage of prior art based on a Wheatstone bridge is that the bridge itself, when flowed through by pure solvent alone, must be in as perfect equilibrium as possible. This requirement raises the cost to manufacture and has been shown to limit the success of viscometers sold using a Wheatstone bridge and pressure transducers. Due to the high sensitivity of the pressure transducers used and the associated extremely limited dynamic range, the range of application of such a device is relatively limited in terms of the possible flow rates.

Another prior art example is U.S. Pat. No. issued to Huebner et al in 1987 entitled “Capillary Viscometer” and discloses a viscometer that measures viscosity by sensing electrical resistance changes in hermetically sealed electrical resistors spaced apart at two separate levels in the tube in which the liquid meniscus is to be detected. Huebner's device has been sold worldwide by Schott Instruments GmbH. However, such prior art devices are not considered ideal since the sample itself is disturbed because of electrical current passing through during measurement of resistance.

Yet another prior art example is U.S. Pat. No. 7,213,439 issued to Trainoff in 2007 entitled “Automatic Bridge Balancing Means and Method for a Capillary Bridge Viscometer”. Trainoff s device used a thermally controlled stage connected within one arm of a bridge of a capillary bridge viscometer so that the bridge can be balanced in situ to provide highly accurate measurement signals. This device included a thermal control technique in order to provide more accurate viscosity measurements. Trainoff s device was assigned to Wyatt Technology Corporation and became one of Wyatt's main instrument product lines. However, these Wyatt devices are typically expensive compared to other viscometers.

As a final prior art example, U.S. Pat. No. 10,551,291 issued to Murphy et al. and assigned to Malvern Panalytical entitled, “Balanced Capillary Bridge Viscometry” discloses a viscometer that uses four hydraulic paths with adjustable flow restrictors and a proprietary balancing device to measure viscosity. This prior art example also has high-cost drawbacks as well due to the complexity of the design and components used.

Clearly, there is a need to provide a viscometer that employs more advanced technology to maintain high accuracy yet be designed such that they are affordable to the entire scientific community and also are designed for ease of maintenance such that most repairs can be done onsite without sending back to the factory. These desired market specifications shall be met by the present invention.

### BRIEF SUMMARY OF THE INVENTION

It is a primary object of the present invention to provide a capillary viscometer that replaces volume or pressure measurement by a direct, in-situ flow measurement by thermal flow sensors.

It is yet another object of the present invention to provide a differential capillary viscometer that uses a direct, in-situ flow measurement by thermal flow sensors using two separate capillaries connected to a component providing flow separation to the two capillaries.

It is a final object of the present invention to provide a differential capillary viscometer that uses a direct, in-situ flow measurement by thermal flow sensors using four separate capillaries connected in a Wheatstone bridge configuration.

### BRIEF DESCRIPTION OF THE DRAWINGS

FIG. 1 is a diagram of a single capillary.

FIG. 2 is a diagram of a thermal flow sensor.

FIG. 3 is a diagram of a differential capillary using two separate capillaries connected to a flow separator.

FIG. 4 is a diagram of a differential capillary using four separate capillaries connected in a Wheatstone bridge configuration.

### DETAILED DESCRIPTION OF THE INVENTION

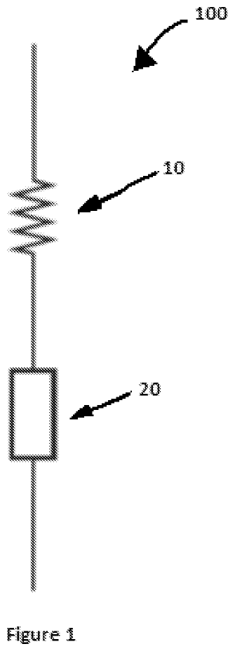

Referring now to the drawings and in particular FIG. 1, the first embodiment of a capillary viscometer is generally designated by reference numeral 100. Capillary viscometer 100 includes a measuring capillary 10 and a thermal flow sensor 20 connected in series. The measurement is made by first measuring the mean flow velocity of a given volume of pure solvent. This procedure is repeated with the sample to be tested, using exactly identical volumes as in the previous measurement. Again, the mean flow velocity is determined. The relative viscosity is then determined from the ratio of the two measured values. This first embodiment represents a significant improvement because it allows the use of capillaries of any type and material and also provides significant accuracy improvements over prior art through a direct flow measurement.

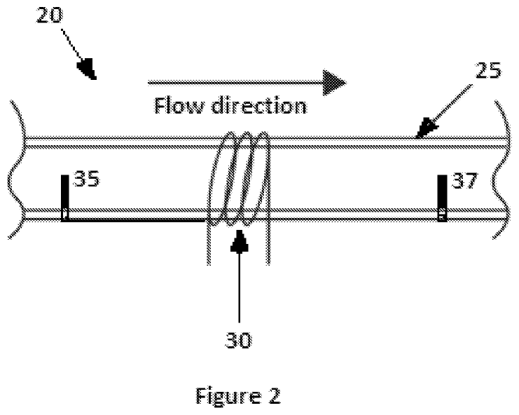

Referring next to FIG. 2, a diagram of a thermal flow sensor 20 is shown. A thermal flow sensor consists of a quartz tube 25, a heating element 30, an upstream temperature sensor 35 and a downstream temperature sensor 37. The heating element 30 is wrapped around a quartz tube 25 in which the liquid flows. The upstream temperature sensor 35 measures the temperature of the flowing liquid before the heating element. The heating element 30 raises the temperature of the flow which is then measured at the downstream temperature sensor 37. The difference in temperature as measured by the upstream and downstream temperature sensors 35 and 37 is a function of the flow velocity of the liquid.

The present invention aims to replace the volume or pressure measurement of prior art viscometers by a direct, in-situ flow measurement using a thermal flow sensor. This solution offers a significant improvement by allowing the use of capillaries of any type and material and provides significant accuracy improvements through a direct flow velocity measurement technique.

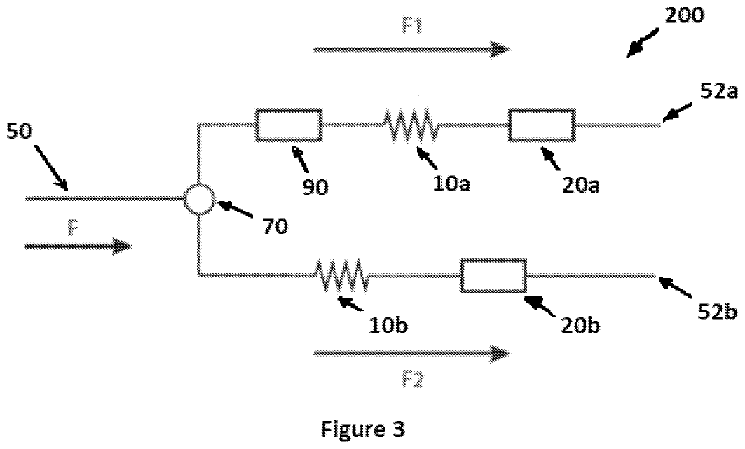

The second embodiment of a differential viscometer is shown in FIG. 3 and is generally designated by reference numeral 200. This second embodiment uses a novel combination of measuring capillaries and thermal flow sensors to provide a differential viscometer. The differential viscometer according to the present invention includes the following components as shown in FIG. 3:

an inlet capillary (50);

a flow splitter (commonly referred to as a T fitting) (70);

a pressure stable vessel (90);

a first measuring capillary (10a);

a first thermal flow sensor (20a);

a first outlet capillary (52a);

a second measuring capillary (10b);

a second thermal flow sensor (20b); and

a second outlet capillary (52b)

The operation of the differential viscometer according to FIG. 3 is as follows. The system is first filled with pure solvent and is continuously flowed through at a constant flow rate. The inlet flow designated F enters the flow splitter 70 and is divided into two partial flows F1 and F2 according to Hagen-Poiseuille's law. By means of suitable measures, the sample to be examined is then introduced into the solvent flow and thus transported to the system. The sample segment is also divided at the flow splitter 70. The pressure stable vessel 90 is located at the beginning of flow F1 and has a volume which is considerably larger than the volume of the inlet capillary 50. When the sample segment reaches the vessel 90, it is very diluted here, so that almost pure solvent continues to flow out at the outlet of vessel 90. In the other branch (flow F2), however, the sample segment flows undisturbed through the measuring capillary 10b. Thus, the apparent resistance of the two branches is changed, because in the first branch (flow F1), the measuring capillary 10a is still flowed through by pure solvent, while the measuring capillary 10b is flowed through by the sample. According to the Hagen-Poiseuille law, the partial flows F1 and F2 will therefore behave inversely to the viscosity change in the measuring capillary 10b and will change accordingly. From this it follows that the ratio F2/F1 gives the relative viscosity of the sample.

In-situ measurement using thermal flow sensors also offers significant advantages over previous prior art solutions, The change in flow within the system is the primary information that results when a sample segment is introduced into the system. Thus, the immediate measurement of the change in flow is directly related to the change in viscosity in the system and is therefore an unbiased method. Furthermore, the measurement of the flow is much simpler than the indirect determination by the system pressure and does not require a balanced system, nor is it sensitive to disturbances such as air bubbles.

One skilled in the art of making viscometers could create other embodiments of the present invention. Some additional examples are described here without the use of additional figure drawings. In yet another embodiment of a differential viscometer, the two separate outlet capillaries 52a and 52b can be brought together by means of another flow splitter 70 to create a common outlet capillary 52c. Also, the position of the thermal flow sensors 20a and 20b can be modified, taking into account that thermal flow sensor 20a is always positioned downstream of the vessel 90. Also possible is to measure the total flow F at the inlet or at the common outlet and to realize only one of the two partial flows F1 and F2. All these variants lead to the same result.

Yet another significant advantage is that a differential viscometer of this design can easily be combined with other measuring devices such as devices for determining the sample concentration or the light scattering of the sample. The aim can be the determination of the intrinsic viscosity or the absolute molar mass. The combination can be in the form of a separate module or as an integral part of the viscometer. Indeed, the ability to integrate the present invention into other measuring instruments gives the present invention a significant advantage over prior art stand-alone viscometers.

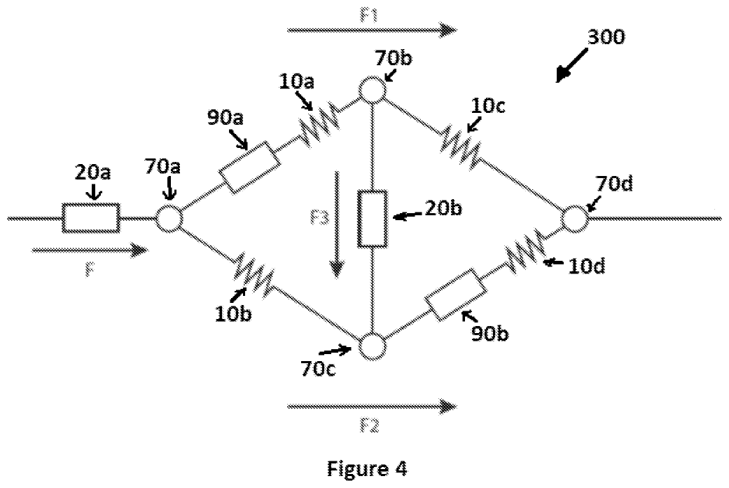

A final embodiment of a viscometer is shown in FIG. 4 and is generally designated by reference numeral 300. This embodiment is a differential viscometer in the form of a Wheatstone bridge. The basis of the bridge is formed by four identical measuring capillaries, constructed analogous to a Wheatstone bridge, which is well known from the field of electronics. Two vessels, each placed in front of one of the four capillaries, have the function of diluting the sample segment there to such an extent that only almost pure solvent flows through the following capillaries.

The function of the viscometer 300 according to FIG. 4 is as follows. The system is first completely filled with pure solvent and is continuously flowed through at a constant flow rate. The inlet thermal flow sensor 20a continuously measures the total flow rate. The flow F at the inlet flow splitter 70a is divided into the two partial flows F1 and F2 according to Hagen-Poiseuille's law. Since all four capillaries are identical, these two partial flows F1 and F2 are also identical. This then leads to identical pressures at flow splitters 70b and 70c, which in turn leads to no flow F3 at thermal flow sensor 20b. By means of suitable measures, the sample to be examined is then introduced into the solvent flow and thus transported to the system. The sample segment is also split at the flow splitter 70a. When the sample segment reaches the vessel 90a, it is very diluted here, so that almost pure solvent continues to flow out (flow F1) at the outlet of the vessel 90.

In the other branch (flow F2), however, the sample segment flows undisturbed through the measuring capillary 10b. Thus, the apparent resistance of the two branches (flows F1 and F2) is changed, because in the first branch (flow F1), the measuring capillaries 10a and 10c still have pure solvent flowing through them, while the measuring capillary 10b has sample flowing through it. According to Hagen-Poiseuille's law, the partial flows F1 and F2 will therefore behave inversely to the viscosity change in measuring capillary 10b and change accordingly. As a result, the pressure at the flow splitters 70b and 70c will no longer be identical and thus a transverse flow F3 will occur, which will be detected by the thermal flow sensor 20b. When the sample then reaches the vessel 90b, it will also be strongly diluted here, the measuring capillary 10d will then flow through as almost pure solvent and thus equilibrium will be restored in the system and the flow F3 will become zero again. Thus, the specific viscosity of the sample is determined from the two flow signals of thermal flow sensor 20a and thermal flow sensor 20b.

One skilled in the art of making viscometers could create yet other embodiments of the present invention shown in FIG. 4. Vessel 90a, for example, can be dispensed with completely without affecting the primary function.

What is claimed is:

1. A capillary viscometer including a fluid flow circuit which is a fluid line and includes therein, in series, a measuring capillary and a thermal flow sensor.

2. A capillary viscometer of claim 1 in which the thermal flow sensor is further comprised of a quartz tube, a heating element wrapped around said quartz tube, a first temperature sensor located inside said quartz tube and upstream of said heating element, and a second temperature sensor located inside said quartz tube and downstream of said heating element.

3. A process for measuring the relative viscosity of a sample consisting essentially of:
(a) first feeding a pure solvent through the capillary viscometer according to claim 1 and measuring the mean flow velocity by using a thermal flow sensor;
(b) feeding a sample consisting of a solute in solution with a solvent through the capillary viscometer according to claim 1 and measuring the mean flow velocity by using a thermal flow sensor; said sample having the same volume as the pure solvent; and
(c) determining the relative viscosity of the sample by calculating the ratio of the two measured flow velocities.

4. A capillary viscometer of claim 1 in which the capillary viscometer is at least partially immersed in a liquid which is maintained at a constant temperature.

5. A differential viscometer including:
(a) a first capillary that creates the inlet fluid line;
(b) a flow splitter connected to the distal end of the first capillary;
(c) a first fluid flow circuit connected to the flow splitter and further containing therein, in sequence from the inlet: a pressure stable vessel, a first measuring capillary, a first thermal flow sensor and a first outlet capillary; and
(d) a second fluid flow circuit also connected to said flow splitter and further containing therein, in sequence from the inlet: a second measuring capillary, a second thermal flow sensor and a second outlet capillary.

6. A process for measuring the relative viscosity of a sample using a differential viscometer according to claim 5 and consisting essentially of:
(a) first feeding a pure solvent through the inlet line of the differential viscometer at a constant flow rate;
(b) feeding a sample consisting of a solute in solution with a solvent through the inlet line of the differential viscometer at a constant flow rate;
(c) the sample will flow through both fluid flow circuits but will be substantially diluted in the first fluid flow circuit due to the vessel which has a substantially larger volume than the fluid flow line;
(d) the sample will remain at its original concentration while flowing through the second flow circuit because there is no vessel in the line;
(e) the partial flows of the first and second fluid flow circuits will behave inversely to the viscosity change created according to the Hagen-Poiseuille law and as a result the thermal flow sensors and measuring capillaries of the first and second fluid flow circuits will detect different flow velocities; and
(f) determining the relative viscosity of the sample by calculating the ratio of the two measured flow velocities of the first and second fluid flow circuits.

7. A differential viscometer of claim 5 in which the vessel used is a mechanical mixing device.

8. A differential viscometer of claim 5 in which the differential viscometer is operated at a constant temperature.

9. A differential viscometer of claim 5 in which the differential viscometer is integrated into a separate device capable of measuring the pressure of the sample at a plurality of locations.

10. A differential viscometer of claim 5 in which the differential viscometer is integrated into a separate device capable of determining the sample concentration.

11. A differential viscometer of claim 5 in which the differential viscometer is integrated into a separate device capable of determining the light scattering of the sample.
